(19) United States
(12) Patent Application Publication
(10) Pub. No.: US 2008/0258855 A1
(43) Pub. Date: Oct. 23, 2008

(54) Transformer and manufacturing method thereof

(76) Inventor: S. J. Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,439

(22) Filed: Apr. 18, 2007

(51) Int. Cl. H01F 17/00; H01F 17/04

(52) U.S. Cl. 336/177; 29/605

(57) ABSTRACT

This invention relates to a transformer and the manufacturing method thereof, wherein the primary winding is made of round-shape metal wire and the secondary winding of flat-shape metal wire, each wire being wound by the winding machine to form a coiled winding, then the two corresponding windings is formed in such a way to be cladded with magnetic material within the die, and the electrodes extending on both ends of each winding is bended to a right position such that the electrodes of the bended winding just project out of the magnetic material. In this manner, in the case the winding is used in the transformer of voltage range below 12V, not only the fabrication of transformer becomes easier and more convenient, but also the gap between the wire turns of the secondary winding is significantly reduced and thus the volume of the transformer can be shrinked. Therefore, the effectiveness in practical application of the innovative transformer and the manufacturing method thereof of the present invention is upgraded both in the entire manufacturing process and in use.

### BACKGROUND OF THE INVENTION

1. Field of the Invention

The present invention relates to a transformer and the manufacturing method thereof, particularly to a transformer used in the application of voltage range below 12V and its manufacturing method. With the transformer and its manufacturing method of the present invention, not only the fabrication of transformer becomes easier and more convenient, but also the volume of the transformer can be significantly reduced. Therefore, the effectiveness in practical application of the innovative transformer and the manufacturing method thereof of the present invention is upgraded both in the entire manufacturing process and in use.

2. Brief Description of the Prior Art

A variety of coils and transformers have been usually seen on PCBs and in electronical products. As shown in FIG. 4, which is a perspective exploded view of an existing structure of transformer, and FIG. 5, which is a cross sectional view of an existing assembled structure of transformer, the transformer (6) is formed by wrapping a primary winding (62) and a secondary winding (63) on the primary section (611) and the secondary section (612) respectively of a bobbin (61) first, then assembling a lamination block (64) made by the stack of a plurality of silicon steel sheets into the outside periphery of the bobbin (64). When a voltage is applied at the primary winding (62), a different voltage will be outputted from the secondary winding (63) due to the action of magnetic field.

Despite the fact that above transformer has expected effectiveness of changing the input voltage to a desired value and output it, however it is discovered in the total manufacturing process that the conductive wire of round cross section forming the primary winding and the secondary winding results in the bulky entire volume of the transformer, which takes large space, according to the demand of bearing input and output voltages with high power on the primary winding and the secondary winding, which are winded on the bobbin respectively. Besides, the entire transformer is arduous and inconvenient in the manufacturing process. In addition, the diameter of conductive wire is large in the secondary winding because of its high current loading, so that the secondary winding has large gap between the conductive wire turns after winding process. This is also another factor to cause the bulky entire volume of the finished transformer and thus takes large space. Therefore, total improvement in the manufacturing of transformer is expected.

In view of the above problem, the inventor of the present invention provides a novel transformer and the manufacturing method thereof based on the experience and knowledge accumulated in the long term involvement of relevant field, with a purpose to improve the defects in existing structure so as to achieve better practical application value.

### SUMMARY OF THE INVENTION

According to the transformer and its manufacturing method of the present invention, the primary winding is made of round-shape metal wire and the secondary winding of flat-shape metal wire, each wire being wound by the winding machine to form a coiled winding, then the two corresponding windings conduct cladded forming with magnetic material within the die, and the electrodes extending on both ends of each winding is bended to a right position such that the electrodes of the bended winding just project out of the magnetic material. In this manner, in the case the winding is used in the transformer of voltage range below 12V, not only the fabrication of transformer becomes easier and more convenient, but also the gap between the wire turns of the secondary winding is significantly reduced and thus the volume of the transformer can be shrinked. Therefore, the effectiveness in practical application of the innovative transformer and the manufacturing method thereof of the present invention is upgraded both in the entire manufacturing process and in use.

### BRIEF DESCRIPTION OF THE DRAWINGS

FIG. 1 is a perspective exploded view showing the structure of the present invention.

FIG. 2 is a cross sectional view of the assembly of the structure of the present invention.

FIG. 3 is a perspective view showing the appearance of the structure of the present invention.

FIG. 4 is a perspective exploded view of a conventional structure of the transformer.

FIG. 5 is a cross sectional view of a conventional assembled structure of the transformer.

### DETAILED DESCRIPTION OF THE PREFERRED EMBODIMENTS

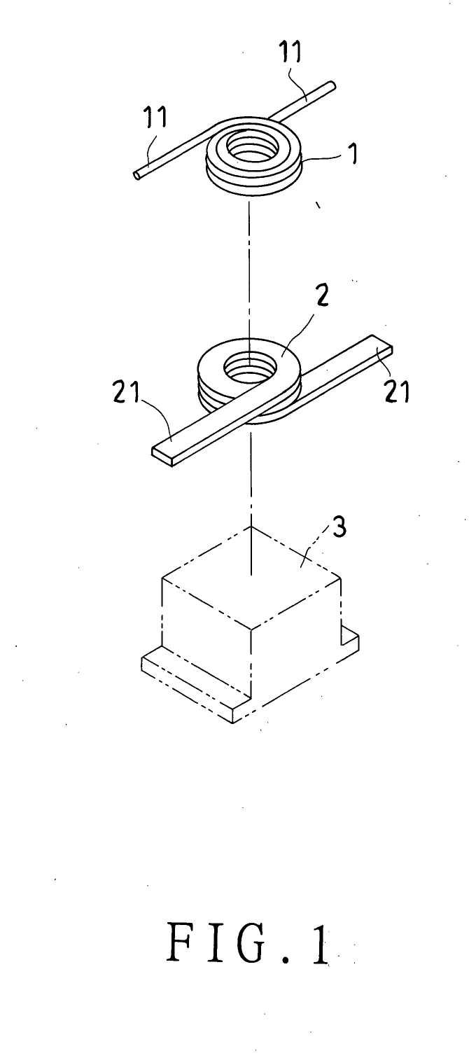

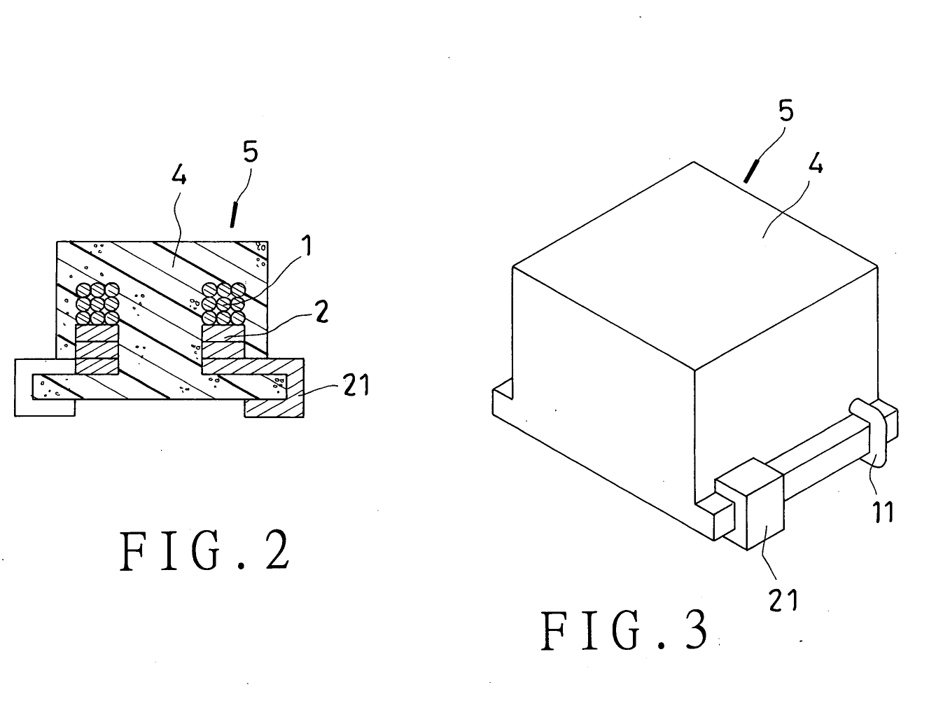

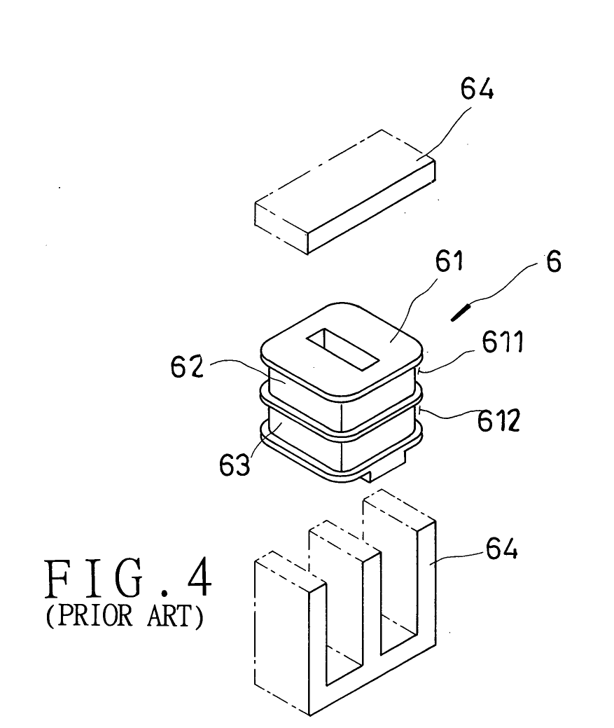

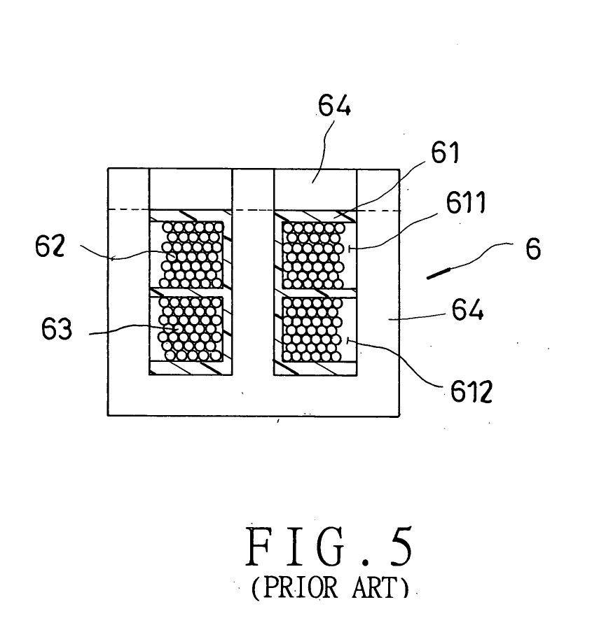

FIG. 1 is a perspective exploded view showing the structure of the present invention. FIG. 2 is a cross sectional view of the assembly of the structure of the present invention. FIG. 3 is a perspective view showing the appearance of the structure of the present invention. Firstly, referring to FIG. 1 to 3, the manufacturing process of the present invention is described as follow:
(a) the primary winding (1) is made of round-shape metal wire and the secondary winding (2) of flat-shape metal wire, each wire being wound by the winding machine to form a coiled winding,
(b) then, the two corresponding primary winding (1) and secondary winding (2) are placed within a die (3),
(c) the die (3) is filled with magnetic material (4)(for example, magnetic powder),
(d) the magnetic material (4) is conducted with cured forming within the die (3)(for example, press forming),
(e) the electrodes (11), (21) extending on two ends of the primary winding (1) and the secondary winding (2) and projecting out of the magnetic material is bended to form a predetermined shape,
(f) the primary winding (1) and the secondary winding (2) is cladded within the magnetic material, and the electrodes (11), (21) of the primary winding (1) and the secondary winding (2) are exposed out of the magnetic material (4) so that a transformer is thus completed.

Based on the foregoing, it is appreciated from the comparison between the manufacturing method and the conventional method that, according to the present invention, the primary winding is made of round-shape metal wire and the secondary winding of flat-shape metal wire, each wire being wound by the winding machine to form a coiled winding, then the two corresponding windings is formed in such a way to be cladded with magnetic material within the die, and the electrodes extending on both ends of each winding is bended to a right position such that the electrodes of the bended winding just project out of the magnetic material. In this manner, in the case the winding is used in the transformer of voltage range below 12V, not only the fabrication of transformer becomes easier and more convenient, but also the gap between the wire turns of the secondary winding is significantly reduced and thus the volume of the transformer can be shrinked. Therefore, the effectiveness in practical application of the innovative transformer and the manufacturing method thereof of the present invention is upgraded both in the entire manufacturing process and in use.

1. A transformer, wherein the primary winding and the secondary winding is cladded with magnetic material, said primary winding being made of round-shape metal wire and said secondary winding of flat-shape metal wire to form respective coiled winding, and the electrodes of said primary winding and said secondary winding being exposed out of the magnetic material, so that a transformer is thus completed.

2. (canceled)

3. A transformer according to claim 1, wherein said magnetic material is a magnetic powder used in press forming.

4. (canceled)
